(19) United States
(12) Patent Application Publication
(10) Pub. No.: US 2008/0105766 A1
(43) Pub. Date: May 8, 2008

(54) Injector

(75) Inventors: Atsushi Murakami, Kariya-city (JP); Shinji Abo, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/806,898

(22) Filed: Jun. 5, 2007

(30) Foreign Application Priority Data
Aug. 1, 2006 (JP) 2006-209494
Jan. 10, 2007 (JP) 2007-2734

(51) Int. Cl. F02M 59/00

(52) U.S. Cl. 239/533.2

(57) ABSTRACT

An injector has the solenoid valve including a solenoid coil, a stator, a stopper, a housing, a terminal, and a bush. The stator has the solenoid coil therein, and attracts an armature to one side in an axial direction of the armature upon energization of the solenoid coil. The stator is on the one side of the armature. The stopper restricts an amount of displacement of the armature toward the stator. The housing is on the one side of the stator. The terminal is inserted in the housing, and electrically connected to the solenoid coil. The bush is received by the housing, and insulates the terminal from the housing. The bush is forcibly inserted into an attachment hole, which is formed in the housing.

### CROSS REFERENCE TO RELATED APPLICATION

This application is based on and incorporates herein by reference Japanese Patent Application No. 2006-209494 filed on Aug. 1, 2006, and Japanese Patent Application No. 2007-2734 filed on Jan. 10, 2007.

### BACKGROUND OF THE INVENTION

1. Field of the Invention

The present invention relates to an injector.

2. Description of Related Art

In an injector, which supplies fuel to an engine by injecting the fuel, a solenoid valve is conventionally used as an actuator that drives a valve body of an injection nozzle. The solenoid valve opens and closes a back-pressure chamber, which applies pressure to the valve body in a valve closing direction (i.e., direction in which a nozzle hole is closed) and into and out of which fuel flows. When the solenoid valve is operated, pressure of the back-pressure chamber is released and fuel flows out of the back-pressure chamber. Accordingly, pressure applied to the valve body in the valve closing direction decreases. As a result, the valve body opens the nozzle hole and thereby fuel is injected. When the solenoid valve is stopped, the back-pressure chamber is closed and fuel stops flowing out of the back-pressure chamber. Accordingly, pressure applied to the valve body in the valve closing direction increases. As a result, the valve body closes the nozzle hole and thereby injection of fuel is stopped.

According to a conventional injector 100, a solenoid valve 101 includes a stator 104, a stopper 105, a housing 106, a terminal 107, and bushes 108 (FIG. 11A). The stator 104 is disposed on an inner circumferential side of a solenoid coil 102, and attracts an armature 103 to one side in an axial direction upon energization of the solenoid coil 102. The stopper 105 is arranged on an inner circumferential side of the stator 104, and restricts an amount of displacement of the armature 103 toward a stator 104-side. The housing 106 is arranged on the one side of the stator 104 in the axial direction. The terminal 107 is inserted in the housing 106, and electrically connected to the solenoid coil 102. The bushes 108 are received by the housing 106, and insulate the terminal 107 from the housing 106.

When the armature 103 is displaced to the one side in the axial direction upon the energization of the solenoid coil 102, a back-pressure chamber (not shown) is opened (e.g., JP2005-105923A corresponding to EP01669591A1).

The solenoid valve 101 is a precision component, and for example, a gap between the armature 103 and the stator 104 when the armature 103 contacts the stopper 105, is set at tens of micrometers [μm]. After assembly, high-precision grinding processing is performed on a pole-face 111 of the stator 104, which is opposed to the armature 103, and a contact surface 112 of the stopper 105, which the armature 103 contacts. Then, dust generated in the high-precision grinding processing is removed by high-pressure washing or ultrasonic cleaning.

However, the dust, which enters a dead end 114 shown in FIG. 11B, is very difficult to be completely removed. In association with a fuel flow, when the dust reaches a space 117 in the bush 108 (hereafter, an in-bush exposal chamber 117, which corresponds to an O-ring chamber that is formed in the bush 108 and that receives an O-ring 116, for example), to which the terminal 107 is exposed, it is possible that an insulation fault is caused by conduction between the terminal 107 and the housing 106. As well, it is possible that such an insulation fault is caused when a metal foreign object included in fuel reaches the in-bush exposal chamber 117. Furthermore, it is possible that the insulation fault is caused when a conductive compound such as copper sulfide (CuS) is generated after sulfur (S), which is included in fuel, and copper (Cu), which is an element from which the terminal 107 is made, are bonded together.

To prevent the metal foreign object or sulfur from entering the in-bush exposal chamber 117, a gap 118, which is formed between the stopper 105 and the stator 104 in a radial direction, may be filled with resin or the like. However, a structure whereby the gap 118 is filled with resin becomes complex, thereby resulting in high production costs. Also, to ensure a space required for the filling of resin, an area of the pole-face 111 of the stator 104 needs to be decreased, or an area of the contact surface 112 of the stopper 105 needs to be decreased. Nevertheless, the decrease in the area of the pole-face 111 leads to decrease in magnetic attraction, and the decrease in the area of the contact surface 112 causes early wearing of the contact surface 112. In both cases, valve performance is deteriorated.

### SUMMARY OF THE INVENTION

The present invention addresses the above disadvantages. Thus, it is an objective of the present invention to reduce possibility at a low cost that an insulation fault is caused between a terminal and a housing when dust generated in grinding processing, or a metal foreign object or sulfur in fuel reaches an in-bush exposal chamber in a solenoid valve of an injector.

To achieve the objective of the present invention, there is provided an injector, which is for supplying fuel to an engine by injecting the fuel. The injector includes a solenoid valve and a nozzle hole. The nozzle hole is opened by the solenoid valve to inject the fuel. The solenoid valve includes a solenoid coil, a stator, a stopper, a housing, a terminal, and a bush. The solenoid coil is energized. The stator has the solenoid coil therein, and attracts an armature to one side in an axial direction of the armature upon the energization of the solenoid coil. The stator is disposed on the one side of the armature in the axial direction. The stopper is arranged on an inner circumferential side of the stator, and restricts an amount of displacement of the armature toward the stator. The housing is arranged on the one side of the stator in the axial direction. The terminal is inserted in the housing, and electrically connected to the solenoid coil. The bush is received by the housing, and insulates the terminal from the housing. The bush is forcibly inserted into an attachment hole, which is formed in the housing.

To achieve the objective of the present invention, there is also provided an injector, which is for supplying fuel to an engine by injecting the fuel. The injector includes a solenoid valve and a nozzle hole. The nozzle hole is opened by the solenoid valve to inject the fuel. The solenoid valve includes a solenoid coil, a stator, a stopper, a housing, a terminal, and at least two bushes. The solenoid coil is energized. The stator has the solenoid coil therein, and attracts an armature to one side in an axial direction of the armature upon the energization of the solenoid coil. The stator is disposed on the one side of the armature in the axial direction. The stopper is arranged on an inner circumferential side of the stator, and restricts an amount of displacement of the armature toward the stator. The housing is arranged on the one side of the stator in the axial direction. The terminal is inserted in the housing, and electrically connected to the solenoid coil. The at least two bushes are received by the housing, and insulate the terminal from the housing. The at least two bushes are arranged in the axial direction. An opposite-side bush, which is one of any two bushes of the at least two bushes with the any two bushes being adjacent to each other in the axial direction, has a projection on a one-side end portion of the opposite-side bush. The opposite-side bush is disposed on an opposite side in the axial direction, and the opposite side is opposite from the one side in the axial direction. The one-side end portion is positioned on the one side of the opposite-side bush in the axial direction. The projection projects into the one side and is formed annularly to surround the terminal, and the projection is pushed down radially when the projection contacts an opposite-side end portion of a one-side bush of the any two bushes. The one-side bush is disposed on the one side in the axial direction and the opposite-side end portion is positioned on the opposite side of the one-side bush in the axial direction.

Furthermore, to achieve the objective of the present invention, there is provided an injector, which is for supplying fuel to an engine by injecting the fuel. The injector includes a solenoid valve and a nozzle hole. The nozzle hole is opened by the solenoid valve to inject the fuel. The solenoid valve includes a solenoid coil, a stator, a stopper, a housing, a terminal, and at least two bushes. The solenoid coil is energized. The stator has the solenoid coil therein, and attracts an armature to one side in an axial direction of the armature upon the energization of the solenoid coil. The stator is disposed on the one side of the armature in the axial direction. The stopper is arranged on an inner circumferential side of the stator, and restricts an amount of displacement of the armature toward the stator. The housing is arranged on the one side of the stator in the axial direction. The terminal is inserted in the housing, and electrically connected to the solenoid coil. The at least two bushes are received by the housing, and insulate the terminal from the housing. The at least two bushes are arranged in the axial direction. A one-side bush, which is one of any two bushes of the at least two bushes with the any two bushes being adjacent to each other in the axial direction, has a projection on an opposite-side end portion of the one-side bush. The one-side bush is disposed on the one side in the axial direction. The opposite-side end portion is positioned on an opposite side of the one-side bush in the axial direction, and the opposite side is opposite from the one side in the axial direction. The projection projects into the opposite side and is formed annularly to surround the terminal, and the projection is pushed down radially when the projection contacts a one-side end portion of an opposite-side bush of the any two bushes. The opposite-side bush is disposed on the opposite side in the axial direction and the one-side end portion is positioned on the one side of the opposite-side bush in the axial direction.

Also, to achieve the objective of the present invention, there is provided an injector, which is for supplying fuel to an engine by injecting the fuel. The injector includes a solenoid valve and a nozzle hole. The nozzle hole is opened by the solenoid valve to inject the fuel. The solenoid valve includes a solenoid coil, a stator, a stopper, a housing, a terminal, and at least two bushes. The solenoid coil is energized. The stator has the solenoid coil therein, and attracts an armature to one side in an axial direction of the armature upon the energization of the solenoid coil. The stator is disposed on the one side of the armature in the axial direction. The stopper is arranged on an inner circumferential side of the stator, and restricts an amount of displacement of the armature toward the stator. The housing is arranged on the one side of the stator in the axial direction. The terminal is inserted in the housing, and electrically connected to the solenoid coil. The at least two bushes are received by the housing and insulate the terminal from the housing. The at least two bushes are arranged in the axial direction. An annular portion having elasticity is placed to surround the terminal, in at least one of the following areas: an area between any two bushes of the at least two bushes with the any two bushes being adjacent to each other in the axial direction; an area at an opposite-side end portion of an opposite-side bush of the at least two bushes; and an area at a one-side end portion of a one-side bush of the at least two bushes. The opposite-side bush is disposed farther on an opposite side in the axial direction than the rest of the at least two bushes, and the opposite side is opposite from the one side in the axial direction. The opposite-side end portion is positioned on the opposite side of the opposite-side bush in the axial direction. The one-side bush is disposed farther on the one side in the axial direction than the rest of the at least two bushes. The one-side end portion is positioned on the one side of the one-side bush in the axial direction.

Lastly, to achieve the objective of the present invention, there is provided an injector, which is for supplying fuel to an engine by injecting the fuel. The injector includes a solenoid valve and a nozzle hole. The nozzle hole is opened by the solenoid valve to inject the fuel. The solenoid valve includes a solenoid coil, a stator, a stopper, a housing, a terminal, and a plurality of bushes. The solenoid coil is energized. The stator has the solenoid coil therein, and attracts an armature to one side in an axial direction of the armature upon the energization of the solenoid coil. The stator is disposed on the one side of the armature in the axial direction. The stopper is arranged on an inner circumferential side of the stator, and restricts an amount of displacement of the armature toward the stator. The housing is arranged on the one side of the stator in the axial direction. The terminal is inserted in the housing, and electrically connected to the solenoid coil. The plurality of bushes are received by the housing, and insulate the terminal from the housing. The terminal is forcibly inserted into at least one of the plurality of bushes, and penetrates in the axial direction between one end face and an opposite end face of the one of the plurality of bushes. The opposite end face is opposite from the one end face. An outer circumferential portion of a contact end face, which is one of the one end face and the opposite end face, with the contact end face being in contact with any one bush of the plurality of bushes other than the at least one of the plurality of bushes, is surrounded by a dielectric member.

### BRIEF DESCRIPTION OF THE DRAWINGS

The invention, together with additional objectives, features and advantages thereof, will be best understood from the following description, the appended claims and the accompanying drawings in which:

FIG. 1 is an illustrative view showing a configuration of an injector according to a first embodiment of the present invention;

FIG. 2A is a cross-sectional view of a solenoid valve according to the first embodiment;

FIG. 2B is a cross-sectional view of a chief part of the solenoid valve according to the first embodiment;

FIG. 3 is a cross-sectional view of the other side bush according to the first embodiment;

FIG. 4A is a cross-sectional view of a chief part of a solenoid valve according to a second embodiment of the present invention;

FIG. 4B is an illustrative view showing contact between a projection and an end portion of a bush before a load is applied, according to the second embodiment;

FIG. 4C is an illustrative view showing contact between the projection and the end portion of the bush after the load is applied, according to the second embodiment;

FIG. 5 is a cross-sectional view of a chief part of a solenoid valve according to a third embodiment of the present invention;

FIG. 6A is a plan view of two C-shaped members before a load is applied, according to the third embodiment;

FIG. 6B is a cross-sectional view of the two C-shaped members before the load is applied, according to the third embodiment;

FIG. 6C is a plan view of the two C-shaped members after the load is applied, according to the third embodiment;

FIG. 6D is a cross-sectional view of the two C-shaped members after the load is applied, according to the third embodiment;

FIG. 7 is a cross-sectional view of a chief part of a solenoid valve according to a fourth embodiment of the present invention;

FIG. 8A is a cross-sectional view of the other side bush according to a modification to the first embodiment;

FIG. 8B is another cross-sectional view of the other side bush according to the modification to the first embodiment;

FIG. 9 is a cross-sectional view of a solenoid valve according to the modification to the first embodiment;

FIG. 10 is a cross-sectional view of a solenoid valve according to modifications to the first to fourth embodiments;

FIG. 11A is a cross-sectional view of a previously proposed solenoid valve; and

FIG. 11B is a cross-sectional view of a chief part of the previously proposed solenoid valve.

### DETAILED DESCRIPTION OF THE INVENTION

An injector according to a first embodiment supplies fuel to an engine by injecting the fuel after opening a nozzle hole by a solenoid valve. The solenoid valve includes a solenoid coil, a stator, a stopper, a housing, a terminal, and a bush. The solenoid coil is energized. The stator has the solenoid coil therein, and attracts an armature to one side in an axial direction upon the energization of the solenoid coil. The stopper is arranged on an inner circumferential side of the stator, and restricts an amount of displacement of the armature toward a stator-side. The housing is arranged on the one side of the stator in the axial direction. The terminal is inserted in the housing, and electrically connected to the solenoid coil. The bush is received by the housing, and insulates the terminal from the housing. The bush is forcibly inserted into an attachment hole formed in the housing.

The bush is divided into at least two portions in the axial direction. The other side bush, which is disposed on the most other side in the axial direction, is forcibly inserted into the attachment hole.

The other side bush is formed such that a diameter of a part of the other side bush on the one side in the axial direction is smaller than a diameter of an opening of the attachment hole, and a diameter of a part of the other side bush on the other side in the axial direction is larger than the diameter of the opening of the attachment hole. The part of the other side bush on the other side in the axial direction is pressed against the housing.

In addition, according to the injector, the stopper is forcibly inserted into the housing.

According to an injector of a second embodiment, the bush is divided into at least two portions in the axial direction. Among two bushes adjacent to each other in the axial direction, a projection that projects into the one side in the axial direction is formed annularly to surround a terminal, on an end portion (on the one side) of the other side bush, which is disposed on the other side in the axial direction. The projection is pushed down radially by abutting against an end portion (on the other side) of a one side bush, which is disposed on the one side in the axial direction.

Furthermore, on the end portion (on the one side) of the other side bush, a groove is formed on a side, to which the projection is pushed down.

According to an injector of a third embodiment, the bush is divided into at least two portions in the axial direction. An annular portion having elasticity is inserted to surround a terminal, into at least one of the areas between two bushes adjacent to each other in the axial direction, at an end portion (on the other side) of the other side bush, which is disposed on the most other side in the axial direction, and at an end portion (on the one side) of a one side bush, which is disposed on the most one side in the axial direction.

The annular portion has annular members, which are stacked to be inserted to surround the terminal. At least one of the annular members is formed in a C-shaped manner, being a C-shaped member having elasticity in a circumferential direction. At least one of two end faces of the C-shaped member has an inclined portion, which is inclined with respect to a plane perpendicular to the axial direction. As well, an end face of the annular member, which is opposed to the one of the two end faces, has an inclined portion that abuts against the inclined portion of the C-shaped member.

The inclined portion of the C-shaped member and the inclined portion of the annular member opposed to the one of the two end faces are formed in a tapered manner.

According to an injector of a fourth embodiment, the bush is divided into a plurality of portions. A terminal is forcibly inserted into at least one bush, and penetrates between one end face and the other end face of the one bush in the axial direction. Among the one end face and the other end face of the one bush, an outer circumferential portion of the end face, against which the other bush abuts, is surrounded by a dielectric member.

In addition, the dielectric member is a bush, which is different from the one bush.

### FIRST EMBODIMENT

### Configuration of First Embodiment

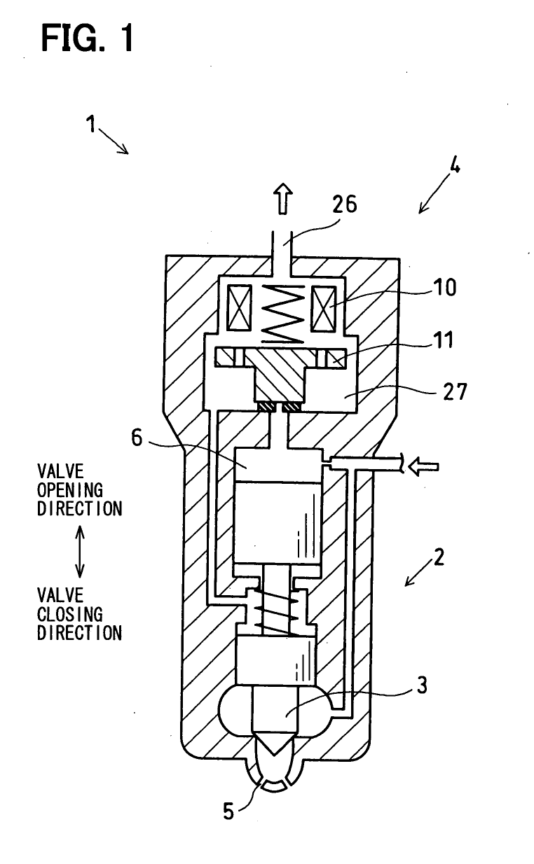

A configuration of an injector 1 according to a first embodiment is described with reference to FIGS. 1 to 3.

The injector 1 may be installed in, for example, a direct fuel-injection engine (not shown) such as a Diesel engine, and supplies fuel to an inside of a cylinder of the engine by injecting it. As shown in FIG. 1, the injector 1 has an injection nozzle 2 and a solenoid valve 4. The injection nozzle 2 injects fuel. The solenoid valve 4 serves as an actuator that drives a valve body 3 of the injection nozzle 2. The injector 1 supplies fuel by injecting it when the solenoid valve 4 actuates the valve body 3 to be driven, thereby opening a nozzle hole 5.

That is, the solenoid valve 4 opens and closes a back-pressure chamber 6, which applies pressure to the valve body 3 in a valve closing direction (i.e., direction in which the nozzle hole 5 is closed) and into and out of which fuel flows. When the solenoid valve 4 is operated, pressure of the back-pressure chamber 6 is released and fuel flows out of the back-pressure chamber 6. Accordingly, pressure applied to the valve body 3 in the valve closing direction decreases. As a result, the valve body 3 moves upward to open the nozzle hole 5 and thereby fuel is injected. When the solenoid valve 4 is stopped, the back-pressure chamber 6 is closed and fuel stops flowing out of the back-pressure chamber 6. Accordingly, pressure applied to the valve body 3 in the valve closing direction increases. As a result, the valve body 3 moves downward to close the nozzle hole 5 and thereby injection of fuel is stopped.

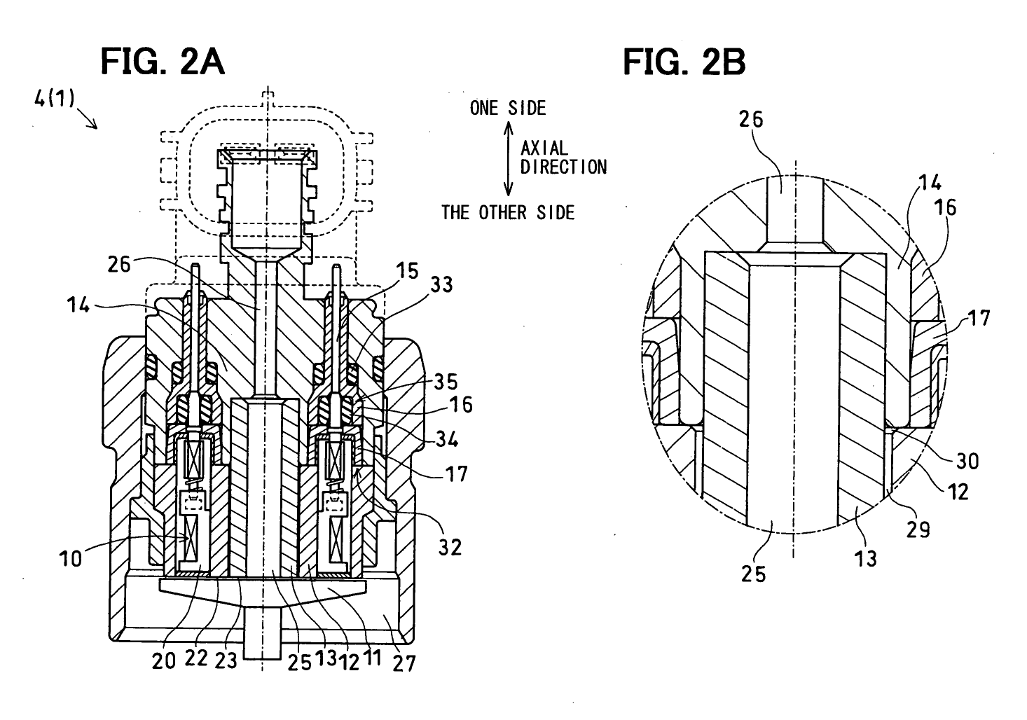

As shown in FIGS. 2A, 2B, the solenoid valve 4 includes a solenoid coil 10, a stator 12, a stopper 13, a housing 14, a terminal 15, and two bushes 16, 17. The solenoid coil 10 is energized. The stator 12 has the solenoid coil 10 therein, and attracts an armature 11 to one side in an axial direction upon the energization of the solenoid coil 10. The stopper 13 is arranged on an inner circumferential side of the stator 12, and restricts an amount of displacement of the armature 11 toward a stator 12-side. The housing 14 is arranged on the one side of the stator 12 in the axial direction. The terminal 15 is inserted in the housing 14, and electrically connected to the solenoid coil 10. The bushes 16, 17 are received by the housing 14, and insulate the terminal 15 from the housing 14.

The solenoid coil 10 is constituted by winding a conductive wire, which has a dielectric coating on its surface, around a bobbin 20 that is made of resin. The solenoid coil 10 is received in the stator 12 and fixed in the stator 12 using epoxy resin.

The stator 12 is set to have a gap of tens of micrometers [μm] between the armature 11 and the stator 12 when the armature 11 contacts the stopper 13. To this end, a pole-face 22 of the stator 12 needs to be finished with extremely high precision. Thus, the pole-face 22 may be finished with high precision in advance before assembly of the stator 12, or grinding processing may be performed on the pole-face 22 together with a contact surface 23 of the stopper 13 simultaneously, to finish the pole-face 22 flush with the contact surface 23, with all parts of the stator 12, the stopper 13 and the like having been assembled. In addition, when the pole-face 22 is finished with high precision in advance, the grinding processing is performed on the contact surface 23 to be finished with the stopper 13 being projecting toward the other side more than the stator 12 in the axial direction.

The stopper 13 is formed in a cylindrical manner and forcibly inserted such that an inner circumferential portion 25 is communicated with a fuel passage 26, which is provided in the housing 14. Additionally, the fuel passage 26 communicates with an outside of the injector 1, and the inner circumferential portion 25, a receiving chamber 27 of the armature 11, and the fuel passage 26 constitute an escape passage, through which fuel in the back-pressure chamber 6 flows out of the injector 1.

Since the stopper 13 needs to be disposed on an inner circumferential side of the stator 12, the stopper 13 is formed in such a manner that an outside diameter of the stopper 13 is smaller than an inside diameter of the stator 12. Accordingly, it is possible that dust generated in the above grinding processing enters a gap 29 in a radial direction between the stopper 13 and the stator 12. Although such dust is removed by high-pressure washing or ultrasonic cleaning after the grinding processing, the dust, which enters a dead end 30 that is constituted of the stopper 13, the stator 12, and the housing 14, is very difficult to be removed. In addition, when the injector 1 is normally operated, it is also possible that a foreign object in fuel enters the gap 29 and the dead end 30.

The terminal 15 is assembled to project from an inside of the stator 12 into the one side in the axial direction. The bushes 16, 17 are arranged in series in the axial direction and received by the housing 14. That is, the bushes 16, 17 are received by the housing 14 such that they are received in an attachment hole 32 formed in the housing 14 in this order to have openings on the other side in the axial direction.

Among the bushes 16, 17, the bush 16, which is disposed on the one side in the axial direction, is formed in such a manner that a diameter of its end portion on the other side is enlarged. An O-ring 33 is placed between the housing 14 and the bush 16. Furthermore, the bush 16 defines an O-ring chamber 35, which receives another O-ring 34, between the bush 16 and the bush 17 (other side bush 17) on the other side in the axial direction. In addition, the O-rings 33, 34 are attached in order to seal in fuel.

Since the O-ring chamber 35 is a space (i.e., in-bush exposal chamber) in the bush 16, to which the terminal 15 is exposed, it is possible that an insulation fault is caused by conduction between the terminal 15 and the housing 14, when a foreign object such as the dust generated in the grinding processing enters the O-ring chamber 35.

The other side bush 17 is pressed against the stator 12 to prevent epoxy resin, which is injected into the inside of the stator 12 before solidification, from leaking. The terminal 15 is forcibly inserted into and penetrates through the other side bush 17.

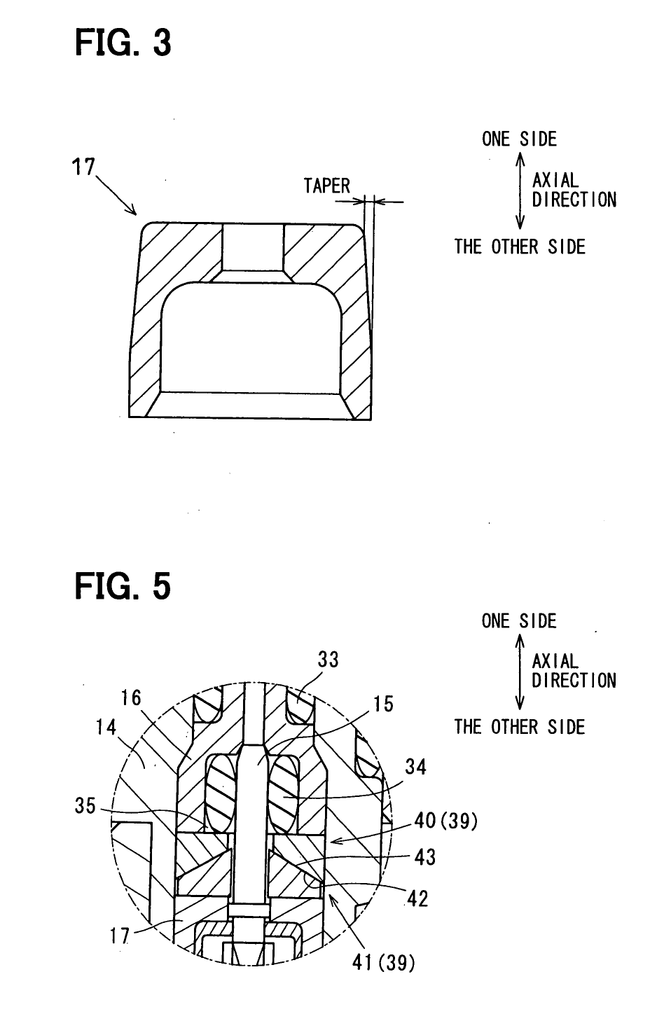

As shown in FIG. 3, the other side bush 17 is formed in a tapered manner such that its diameter gradually increases when the other side bush 17 extends from the one side toward the other side in the axial direction. By forming the other side bush 17 in a tapered manner, a diameter of a part of the other side bush 17 on the one side in the axial direction is smaller than a diameter of an opening of the attachment hole 32, and a diameter of a part of the other side bush 17 on the other side in the axial direction is larger than the diameter of the opening of the attachment hole 32. The part of the other side bush 17 on the other side in the axial direction is pressed against the housing 14. That is, the other side bush 17 is forcibly inserted into the attachment hole 32.

### Effect of First Embodiment

According to the solenoid valve 4 of the injector 1 according to the first embodiment, the other side bush 17 is forcibly inserted into the attachment hole 32.

Accordingly, a fuel passage leading from the dead end 30 to the O-ring chamber 35 is blocked. Thus, the foreign object such as the dust generated in the grinding processing is prevented from reaching the O-ring chamber 35. Besides, by making the diameter of the other side bush 17 larger than that of the attachment hole 32 in whole or partly in the axial direction, the other side bush 17 can be forcibly inserted into the attachment hole 32, which results in low-cost assembly. Thus, in the solenoid valve 4, the possibility that the foreign object such as the dust generated in the grinding processing enters the O-ring chamber 35 and that the insulation fault is caused between the terminal 15 and the housing 14 can be reduced at a low cost.

Moreover, the other side bush 17, which is disposed on the other side more than other members in the axial direction, is forcibly inserted into the attachment hole 32.

Consequently, the fuel passage leading to the O-ring chamber 35 can be blocked by the other side bush 17, which is located nearest to a fuel flow area. Thus, the foreign object such as the dust generated in the grinding processing can be effectively prevented from reaching the O-ring chamber 35.

Also, the other side bush 17 is formed in a tapered manner such that its diameter gradually increases when the other side bush 17 extends from the one side toward the other side in the axial direction, and the part of the other side bush 17 on the other side in the axial direction is pressed against the housing 14.

As a result, by loosely inserting the part of the other side bush 17 on the one side in the axial direction into the attachment hole 32 first, and then pushing the other part into the attachment hole 32, the other side bush 17 can be forcibly inserted into the attachment hole 32. Thus, the other side bush 17 can be easily forcibly inserted.

### SECOND EMBODIMENT

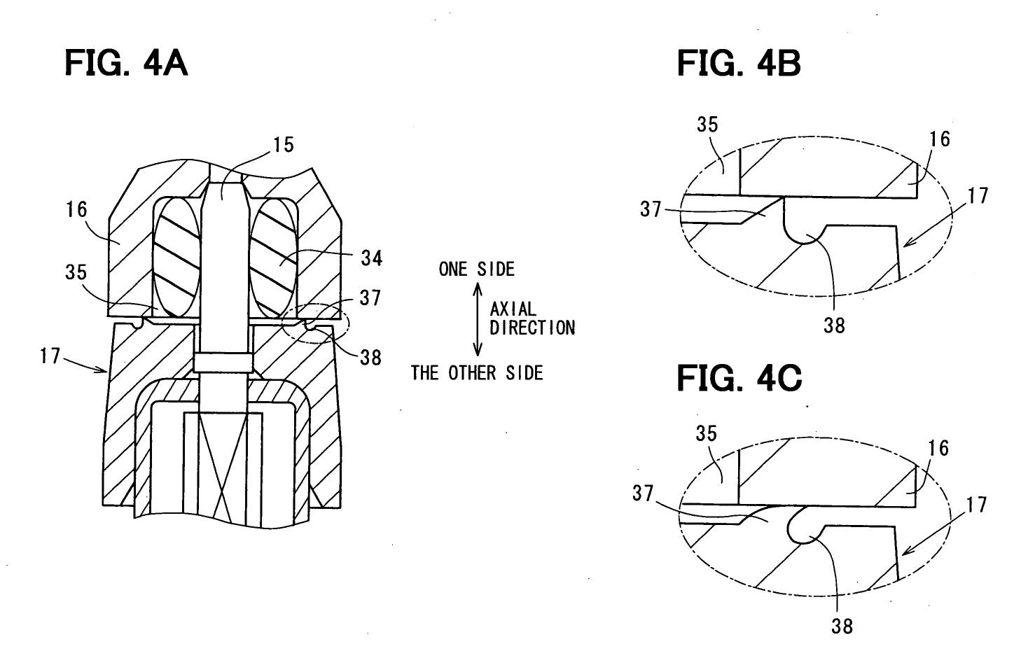

In an injector 1 according to a second embodiment, as shown in FIGS. 4A to 4C, the other side bush 17 has a projection 37, which projects into one side in an axial direction, on its end portion on the one side in the axial direction. The projection 37 is formed annularly to surround a terminal 15, and pushed down radially by abutting against an end portion of a bush 16 on the other side in the axial direction.

Accordingly, surrounding the terminal 15, the bush 16 and the other side bush 17 are reliably closely attached to each other in the axial direction. Thus, a foreign object such as dust generated in grinding processing can be prevented from reaching an O-ring chamber 35. As well, the projection 37 is provided at a low cost, so that in a solenoid valve 4, possibility that the foreign object such as the dust generated in the grinding processing enters the O-ring chamber 35 and that an insulation fault is caused between the terminal 15 and a housing 14 can be reduced at a low cost.

In addition, since the projection 37 abuts against the end portion of the bush 16 on the other side in the axial direction, and the bush 16 and the other side bush 17 are closely attached to each other, a load is applied in the axial direction. However, because the projection 37 is pushed down radially outward, damage to the bush 16 and the other side bush 17 is reduced.

Furthermore, a groove 38 is provided on the end portion of the other side bush 17 on the one side in the axial direction. The groove 38 is formed radially outward of the projection 37, that is, in an area toward which the projection 37 is pushed down.

Accordingly, the groove 38 receives the projection 37 that is pushed down, so that total length of the bush 16 and the other side bush 17 in the axial direction can be prevented from being made large. Thus, the projection 37 can be formed to project further, and thereby the bush 16 and the other side bush 17 can be even more closely attached to each other.

### THIRD EMBODIMENT

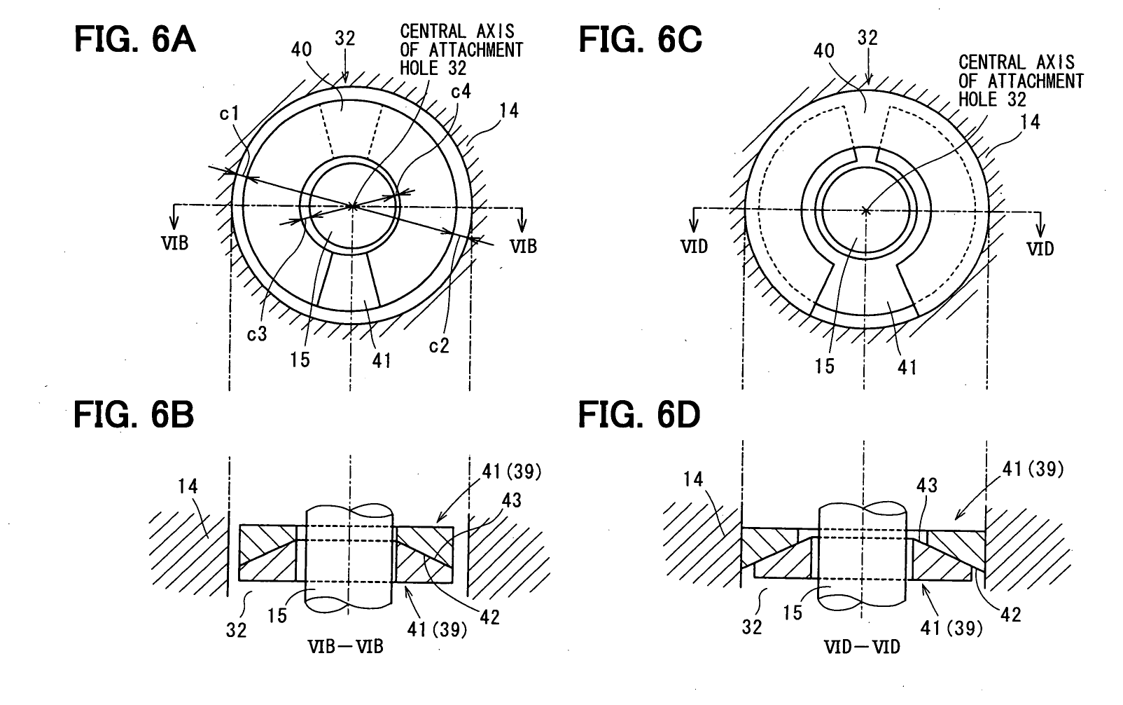

In an injector 1 according to a third embodiment, as shown in FIGS. 5 to 6D, an annular portion 39, which has elasticity, is inserted between the bush 16 and the other side bush 17 to surround a terminal 15. The annular portion 39 has two annular members 40, 41, which are stacked to be inserted to surround the terminal 15. The annular members 40, 41 are formed in a C-shaped manner (i.e., the annular members 40, 41 have respective missing portions in a circumferential direction), and are C-shaped members having elasticity in the circumferential direction (hereafter, the annular members 40, 41 are referred to as C-shaped members 40, 41 respectively). The C-shaped members 40, 41 are arranged in contact with each other, such that their respective end faces, which are formed in a tapered manner and opposed to each other, are brought into contact with each other.

That is, the other-side end face 42 of the C-shaped member 40, which is disposed on one side in an axial direction, is formed to be recessed toward the one side in the axial direction in a tapered manner, and a one-side end face 43 of the C-shaped member 41, which is disposed on the other side in the axial direction, is formed projecting into the one side in the axial direction in a tapered manner (hereafter, the other-side end face 42 of the C-shaped member 40 and the one-side end face 43 of the C-shaped member 41 are referred to as taper end faces 42, 43, respectively). The taper end faces 42, 43 are brought into contact with each other.

Accordingly, when a load is applied to a stacked portion of the C-shaped members 40, 41 in the axial direction, component force along the taper end faces 42, 43 and perpendicular to the taper end faces 42, 43 are applied. Thus, the taper end face 42 slides on the taper end face 43 toward an outer circumferential side and thereby a diameter of the C-shaped member 40 increases. As well, the taper end face 43 slides on the taper end face 42 toward an inner circumferential side and thereby a diameter of the C-shaped member 41 decreases. Therefore, height of the stacked portion of the C-shaped members 40, 41 is decreased by the load applied in the axial direction, and the stacked portion of the C-shaped members 40, 41 elastically urges the bush 16 toward the one side in the axial direction and elastically urges the other side bush 17 toward the other side in the axial direction.

Consequently, surrounding the terminal 15, the stacked portion of the C-shaped members 40, 41 is closely attached to an end portion of the bush 16 on the other side in the axial direction and an end portion of the other side bush 17 on the one side in the axial direction. Thus, a foreign object such as dust generated in grinding processing can be prevented from reaching an O-ring chamber 35. Moreover, the stacked portion of the C-shaped members 40, 41 is provided at a low cost. Thus, in a solenoid valve 4, possibility that the foreign object such as the dust generated in the grinding processing enters the O-ring chamber 35 and that an insulation fault is caused between the terminal 15 and a housing 14 can be reduced at a low cost.

In addition, a clearance on an outer circumferential side is formed between the C-shaped member 40 before the load is applied in the axial direction, and the housing 14. Given values c1, c2 of the clearances on the outer circumferential side, which are opposite from each other with a central axis of an attachment hole 32 being their symmetry center, a value (c1+c2) is set to be smaller than a possible increase in the diameter of the C-shaped member 40 due to the load applied in the axial direction.

On the other hand, a clearance on an inner circumferential side is formed between the C-shaped member 41 before the load is applied in the axial direction, and the terminal 15. Given values c3, c4 of the clearances on the inner circumferential side, which are opposite from each other with the central axis of the attachment hole 32 being their symmetry center, a value (c3+c4) is set to be larger than a possible decrease in the diameter of the C-shaped member 41 due to the load applied in the axial direction.

Accordingly, when the load is applied in the axial direction, the diameter of the C-shaped member 40 is increased until an increase in the diameter coincides with the value (c1+c2). As a result, a generally entire outer circumference of the C-shaped member 40 abuts against the housing 14 because of the load applied in the axial direction. Thus, axis alignment of the C-shaped member 40 can be carried out autonomously by the load applied in the axial direction without the axis alignment of the C-shaped member 40 before the load is applied in the axial direction.

On the other hand, the diameter of the C-shaped member 41 stops decreasing when a decrease in the diameter due to the load applied in the axial direction coincides with the possible decrease. An entire inner circumference of the C-shaped member 41 does not abut against the terminal 15, thereby forming the clearance even after the load is applied in the axial direction, and central axes of the C-shaped members 40, 41 immediately coincide with each other because of the load applied in the axial direction. Thus, axis alignment of the C-shaped member 41 can be carried out autonomously as well, by the load applied in the axial direction without the axis alignment of the C-shaped member 41 before the load is applied in the axial direction.

### FOURTH EMBODIMENT

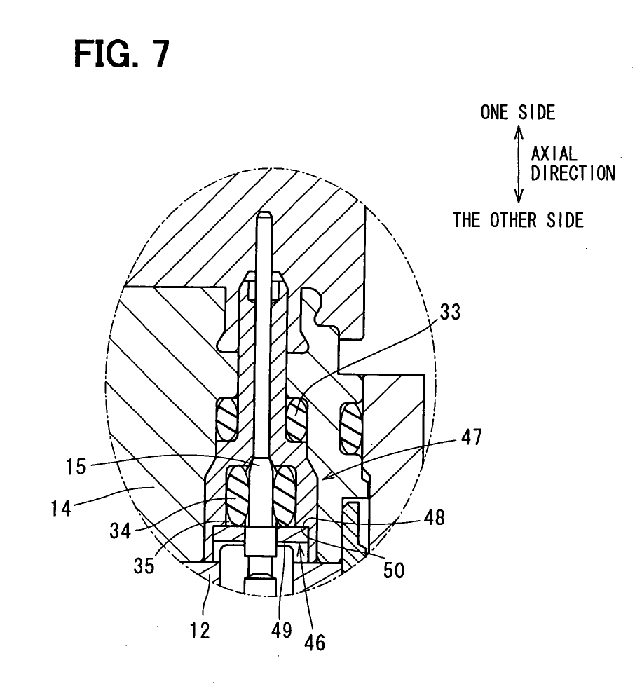

As shown in FIG. 7, an injector 1 according to a fourth embodiment includes a bush 46 and a bush 47. The bush 46 is plate-like, and a terminal 15 is forcibly inserted into and penetrates through the bush 46. The bush 46 is forcibly inserted into the bush 47, and the bush 47 and the bush 46 define an O-ring chamber 35. That is, the terminal 15 is forcibly inserted into the bush 46 and penetrates through the bush 46 between one end face 48 and the other end face 49 of the bush 46 in an axial direction. The bush 46 is forcibly inserted into the bush 47, such that the one end face 48 of the bush 46 is closely attached on a stage portion 50, which is formed on an inner circumference of the bush 47. Accordingly, the one end face 48 and the inner circumference of the bush 47 define the O-ring chamber 35, and an outer circumferential portion of the one end face 48 is surrounded by the bush 47, which is a dielectric member.

Consequently, a route, along which a foreign object such as dust generated in grinding processing enters the O-ring chamber 35, is made long like a maze. Also, an electrical leakage route is difficult to be formed from a metal foreign object or a conductive compound between the terminal 15 and a housing 14 or a stator 12. Furthermore, the surrounding of the outer circumferential portion of the one end face 48 by the bush 47, which is the dielectric member, can be carried out at a low cost. Thus, in a solenoid valve 4, possibility that an insulation fault is caused between the terminal 15 and the housing 14 or the like by the foreign object such as the dust generated in the grinding processing can be reduced at a low cost.

By surrounding the outer circumferential portion of the one end face 48 by the bush 47, another dielectric member for surrounding the one end face 48 does not need to be provided. Thus, the above effect can be produced without increasing the number of components.

### (Modifications)

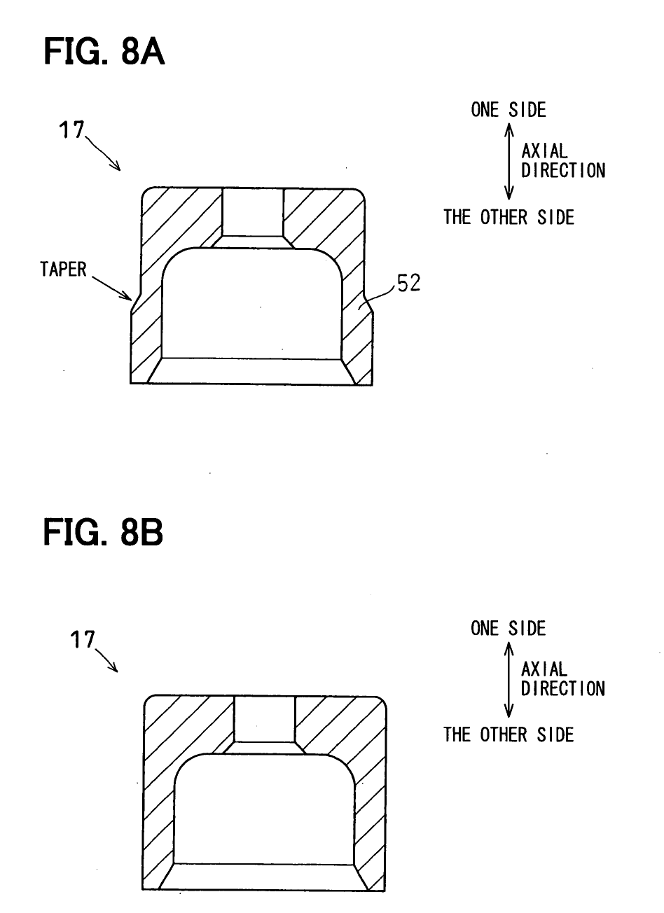

According to the injector 1 of the first embodiment, the other side bush 17 is formed in a tapered manner such that its diameter gradually increases when the other side bush 17 extends from the one side toward the other side in the axial direction, and the part of the other side bush 17 on the other side in the axial direction is pressed against the housing 14. However, as shown in FIG. 8A, by forming a stage portion 52, a diameter of which increases in a relatively small area when it extends from the one side toward the other side in the axial direction, a part of the other side bush 17 on the other side in the axial direction may be pressed against the housing 14. As shown in FIG. 8B, by setting the diameter of the other side bush 17 to be larger than the diameter of the opening of the attachment hole 32 in a nearly overall range in the axial direction, the other side bush 17 may be pressed against the housing 14 in its nearly overall range in the axial direction.

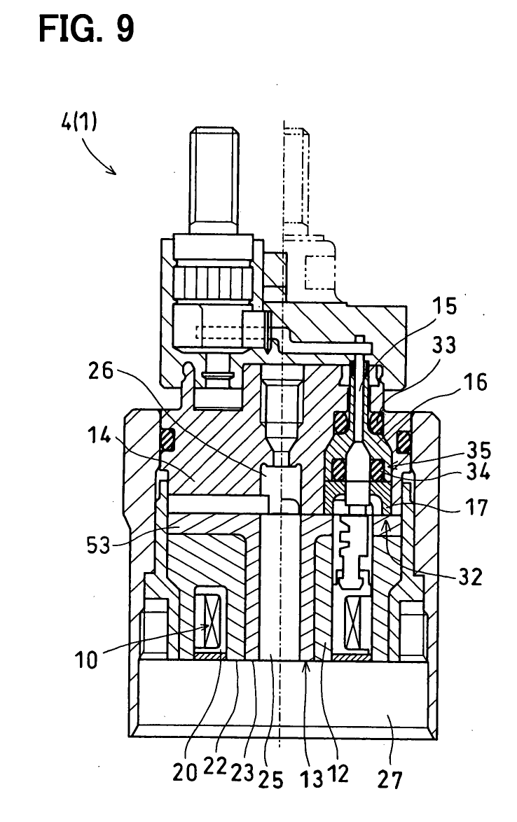

According to the injector 1 of the first embodiment, the stopper 13 is formed in a cylindrical manner, and forcibly inserted into the housing 14. However, as shown in FIG. 9, a flange 53 may be formed on the one side of the stopper 13 in the axial direction, and held between the housing 14 and the stator 12, so that the stopper 13 may be assembled.

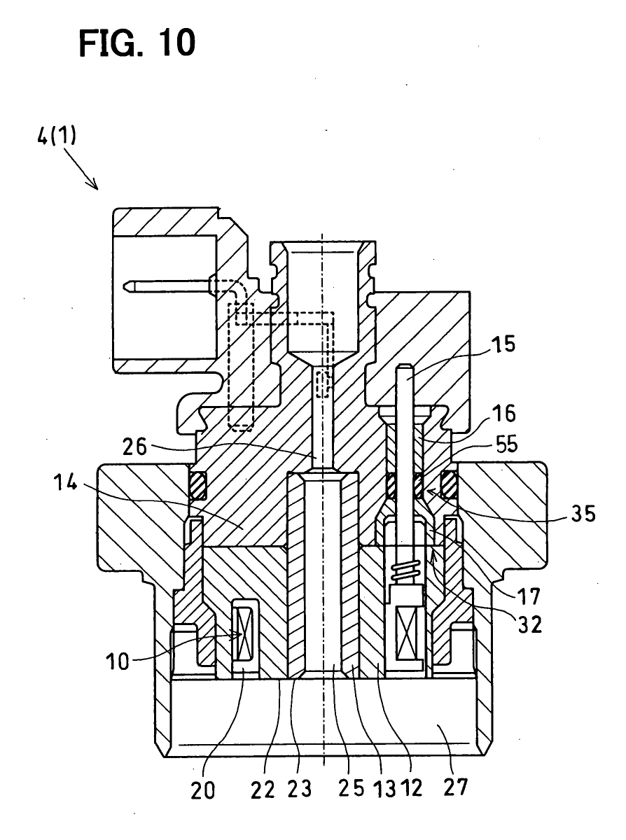

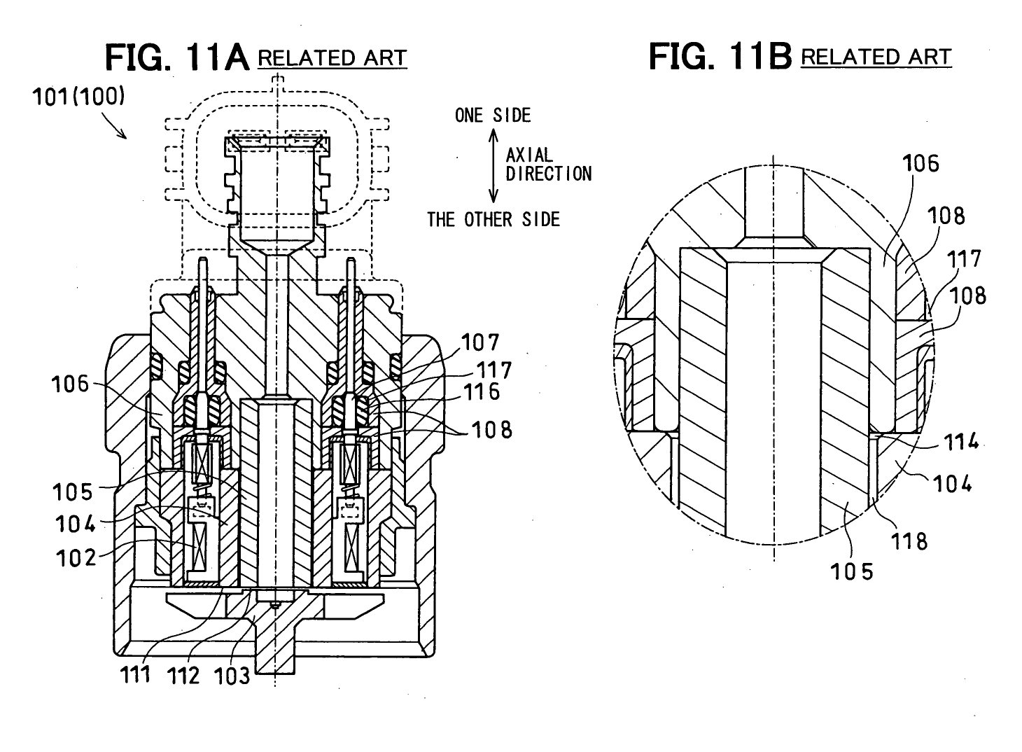

According to the injectors 1 of the first to fourth embodiments, the bush 16 and the other side bush 17 provide electrical isolation between the terminal 15 and the housing 14, and the O-rings 33, 34 are arranged in positions where they do not fulfill an insulating function, and only seal in fuel. However, as shown in FIG. 10, as well as sealing in fuel, an O-ring 55 may provide the electrical isolation between the terminal 15 and the housing 14 According to the injectors 1 of the first to third embodiments, the bush 16 and the other side bush 17 are arranged in the axial direction. However, one bush may be disposed, or three bushes and above may be arranged in the axial direction. When bushes are arranged in the axial direction, the bushes that need to be forcibly inserted may be determined according to a situation in which the in-bush exposal chamber is formed.

According to the solenoid valve 4 of the second embodiment, the other side bush 17 has the projection 37 on its end portion on the one side in the axial direction. However, the bush 16 may have the projection 37 on its end portion on the other side in the axial direction, and the projection 37 may abut against the end portion of the other side bush 17 on the one side in the axial direction.

According to the injector 1 of the second embodiment, the projection 37 is pushed down radially outward, and the groove 38 is formed radially outward of the projection 37. However, the projection 37 may be formed to be pushed down radially inward, and the groove 38 may be formed radially inward of the projection 37.

Furthermore, according to the injector 1 of the second embodiment, the bush 16 and the other side bush 17 are arranged in the axial direction. However, three bushes and above may be arranged in the axial direction. In such a case, the bush, on which the projection 37 and the groove 38 need to be formed, may be determined according to the situation in which the in-bush exposal chamber is formed.

According to the injector 1 of the third embodiment, the annular portion 39 is inserted between the bush 16 and the other side bush 17. However, the annular portion 39 may be inserted in the end portion of the other side bush 17 on the other side in the axial direction or in the end portion of the bush 16 on the one side in the axial direction. Also, the annular portion 39 may be inserted into two of the following areas, that is, the areas between the bush 16 and the other side bush 17, at the end portion of the other side bush 17 on the other side, and at the end portion of the bush 16 on the one side.

Furthermore, according to the injector 1 of the third embodiment, the annular portion 39 includes the C-shaped members 40, 41. However, the annular portion 39 may include an annular member having a shape other than the C-shape, and the annular portion 39 may include one annular member or three annular members and above.

Moreover, according to the injector 1 of the third embodiment, both of the annular members, which are inserted between the bush 16 and the other side bush 17, are the C-shaped members 40, 41 having respective missing portions in the circumferential direction. However, the C-shaped member 40 may be an annular member having the taper end face 42 without a missing portion. The taper end face 42 of this annular member may contact the taper end face 43 of the C-shaped member 41. As well, the C-shaped member 41 may be an annular member having the taper end face 43 without a missing portion. The taper end face 43 of this annular member may contact the taper end face 42 of the C-shaped member 40.

Also, according to the injector 1 of the third embodiment, although the C-shaped member 40 contacts the C-shaped member 41 by bringing into contact the taper end face 42 and the taper end face 43, which are opposed to each other, shapes of two end faces opposed to each other are not limited to the taper shapes. That is, at their respective certain parts, the two end faces have inclined portions, which are inclined with respect to a plane perpendicular to the axial direction. Then, the inclined portions may abut against each other. This inclined portion may be formed in a tapered manner or may have a curved surface. Furthermore, the annular members may be provided such that the entire end faces opposed to each other have the inclined portions.

In addition, in regard to the C-shaped members 40, 41 in the third embodiment, the entire end faces opposed to each other are formed in a tapered manner and constitute the inclined portions respectively, thereby forming the taper end faces 42, 43.

Additionally, according to the injector 1 of the third embodiment, the value (c1+c2) corresponding to the sum of the clearances on the outer circumferential side is set to be smaller than the possible increase in the diameter of the C-shaped member 40. When the outer circumference of the C-shaped member 40 abuts against the housing 14 because of the load applied in the axial direction, the axis alignments of the C-shaped members 40, 41 are carried out. However, by setting the value (c3+c4) corresponding to the sum of the clearances on the inner circumferential side to be smaller than the possible decrease in the diameter of the C-shaped member 41, and making the inner circumference of the C-shaped member 41 abut against the terminal 15 because of the load applied in the axial direction, the axis alignments of the C-shaped members 40, 41 may be carried out.

According to the injector 1 of the third embodiment, the bush 16 and the other side bush 17 are arranged in the axial direction. However, three bushes and above may be arranged in the axial direction. In such a case, positions, into which the annular members such as the C-shaped members 40, 41 need to be inserted, may be determined according to the situation in which the in-bush exposal chamber is formed.

The injector 1 according to the fourth embodiment includes the plate-like bush 46 and the bush 47, which surrounds the outer circumferential portion of the one end face 48 of the bush 46. However, two bushes (e.g., the bush 16 and the other side bush 17 in the first to third embodiments) may be arranged in series in the axial direction, and an outer circumferential portion of a contact surface between the two bushes may be surrounded by a dielectric material, which is different from the two bushes. In this case, three bushes and above may be arranged in series in the axial direction. When three bushes and above are arranged in the axial direction, positions where outer circumferential portions of contact surfaces are covered may be determined according to the situation in which the in-bush exposal chamber is formed.

Additional advantages and modifications will readily occur to those skilled in the art. The invention in its broader terms is therefore not limited to the specific details, representative apparatus, and illustrative examples shown and described.

What is claimed is:

1. An injector for supplying fuel to an engine by injecting the fuel, the injector comprising:
a solenoid valve; and
a nozzle hole, wherein:
the nozzle hole is opened by the solenoid valve to inject the fuel; and
the solenoid valve includes:
a solenoid coil that is energized;
a stator that has the solenoid coil therein, and attracts an armature to one side in an axial direction of the armature upon the energization of the solenoid coil, wherein the stator is disposed on the one side of the armature in the axial direction;
a stopper that is arranged on an inner circumferential side of the stator, and restricts an amount of displacement of the armature toward the stator;
a housing that is arranged on the one side of the stator in the axial direction;
a terminal that is inserted in the housing, and electrically connected to the solenoid coil; and
a bush that is received by the housing, and insulates the terminal from the housing, wherein the bush is forcibly inserted into an attachment hole, which is formed in the housing.

2. The injector according to claim 1, wherein the bush is one of at least two bushes that are arranged in the axial direction, and the one of the at least two bushes is forcibly inserted into the attachment hole, wherein the one of the at least two bushes is disposed farther on an opposite side in the axial direction than the rest of the at least two bushes, and the opposite side is opposite from the one side in the axial direction.

3. The injector according to claim 2, wherein:
the one of the at least two bushes is formed such that a diameter of a part of the one of the at least two bushes on the one side in the axial direction is smaller than a diameter of an opening of the attachment hole, and a diameter of a part of the one of the at least two bushes on the opposite side in the axial direction is larger than the diameter of the opening of the attachment hole; and
the part of the one of the at least two bushes on the opposite side is pressed against the housing.

4. The injector according to claim 2, wherein:
the one of the at least two bushes is formed such that a diameter of the one of the at least two bushes is larger than a diameter of an opening of the attachment hole in a generally overall range of the one of the at least two bushes in the axial direction; and
the generally overall range of the one of the at least two bushes in the axial direction is pressed against the housing.

5. The injector according to claim 1, wherein the stopper is forcibly inserted in the housing.

6. The injector according to claim 1, wherein the stopper has a flange that extends radially, and the flange is positioned between the housing and the stator.

7. An injector for supplying fuel to an engine by injecting the fuel, the injector comprising:
a solenoid valve; and
a nozzle hole, wherein:
the nozzle hole is opened by the solenoid valve to inject the fuel; and
the solenoid valve includes:
a solenoid coil that is energized;
a stator that has the solenoid coil therein, and attracts an armature to one side in an axial direction of the armature upon the energization of the solenoid coil, wherein the stator is disposed on the one side of the armature in the axial direction;
a stopper that is arranged on an inner circumferential side of the stator, and restricts an amount of displacement of the armature toward the stator; a housing that is arranged on the one side of the stator in the axial direction;
a terminal that is inserted in the housing, and electrically connected to the solenoid coil; and
at least two bushes that are received by the housing, and insulate the terminal from the housing, wherein:
the at least two bushes are arranged in the axial direction; and
an opposite-side bush, which is one of any two bushes of the at least two bushes with the any two bushes being adjacent to each other in the axial direction, has a projection on a one-side end portion of the opposite-side bush, wherein:
the opposite-side bush is disposed on an opposite side in the axial direction, and the opposite side is opposite from the one side in the axial direction;
the one-side end portion is positioned on the one side of the opposite-side bush in the axial direction; and
the projection projects into the one side and is formed annularly to surround the terminal, and the projection is pushed down radially when the projection contacts an opposite-side end portion of a one-side bush of the any two bushes, wherein the one-side bush is disposed on the one side in the axial direction and the opposite-side end portion is positioned on the opposite side of the one-side bush in the axial direction.

8. The injector according to claim 7, wherein the opposite-side bush has a groove on the one-side end portion of the opposite-side bush, and the groove is located in an area toward which the projection is pushed down.

9. An injector for supplying fuel to an engine by injecting the fuel, the injector comprising:
a solenoid valve; and
a nozzle hole, wherein:
the nozzle hole is opened by the solenoid valve to inject the fuel; and
the solenoid valve includes:
a solenoid coil that is energized;
a stator that has the solenoid coil therein, and attracts an armature to one side in an axial direction of the armature upon the energization of the solenoid coil, wherein the stator is disposed on the one side of the armature in the axial direction;
a stopper that is arranged on an inner circumferential side of the stator, and restricts an amount of displacement of the armature toward the stator;
a housing that is arranged on the one side of the stator in the axial direction;
a terminal that is inserted in the housing, and electrically connected to the solenoid coil; and
at least two bushes that are received by the housing, and insulate the terminal from the housing, wherein:
the at least two bushes are arranged in the axial direction; and
a one-side bush, which is one of any two bushes of the at least two bushes with the any two bushes being adjacent to each other in the axial direction, has a projection on an opposite-side end portion of the one-side bush, wherein:
the one-side bush is disposed on the one side in the axial direction;
the opposite-side end portion is positioned on an opposite side of the one-side bush in the axial direction, and the opposite side is opposite from the one side in the axial direction; and
the projection projects into the opposite side and is formed annularly to surround the terminal, and the projection is pushed down radially when the projection contacts a one-side end portion of an opposite-side bush of the any two bushes, wherein the opposite-side bush is disposed on the opposite side in the axial direction and the one-side end portion is positioned on the one side of the opposite-side bush in the axial direction.

10. The injector according to claim 9, wherein the one-side bush has a groove on the opposite-side end portion of the one-side bush, and the groove is located in an area toward which the projection is pushed down.

11. An injector for supplying fuel to an engine by injecting the fuel, the injector comprising:
a solenoid valve; and
a nozzle hole, wherein:
the nozzle hole is opened by the solenoid valve to inject the fuel; and
the solenoid valve includes:
a solenoid coil that is energized;
a stator that has the solenoid coil therein, and attracts an armature to one side in an axial direction of the armature upon the energization of the solenoid coil, wherein the stator is disposed on the one side of the armature in the axial direction;
a stopper that is arranged on an inner circumferential side of the stator, and restricts an amount of displacement of the armature toward the stator;
a housing that is arranged on the one side of the stator in the axial direction;
a terminal that is inserted in the housing, and electrically connected to the solenoid coil; and
at least two bushes that are received by the housing and insulate the terminal from the housing, wherein:
the at least two bushes are arranged in the axial direction; and
an annular portion having elasticity is placed to surround the terminal, in at least one of the following areas:
an area between any two bushes of the at least two bushes with the any two bushes being adjacent to each other in the axial direction;
an area at an opposite-side end portion of an opposite-side bush of the at least two bushes, wherein:
the opposite-side bush is disposed farther on an opposite side in the axial direction than the rest of the at least two bushes, and the opposite side is opposite from the one side in the axial direction; and
the opposite-side end portion is positioned on the opposite side of the opposite-side bush in the axial direction; and
an area at a one-side end portion of a one-side bush of the at least two bushes, wherein:
the one-side bush is disposed farther on the one side in the axial direction than the rest of the at least two bushes; and
the one-side end portion is positioned on the one side of the one-side bush in the axial direction.

12. The injector according to claim 11, wherein the annular portion includes a plurality of annular members, which are stacked to surround the terminal, and at least one of the plurality of annular members is a C-shaped member, which is formed in a C-shaped manner and which has elasticity in a circumferential direction, wherein:
at least one of two end faces of the C-shaped member has an inclined portion, which is inclined with respect to a plane perpendicular to the axial direction; and
an end face of any one of the plurality of annular members, with the end face being opposed to the inclined portion, has an end-face inclined portion that abuts against the inclined portion.

13. The injector according to claim 12, wherein the inclined portion of the at least one of two end faces of the C-shaped member, and the end-face inclined portion of the end face of any one of the plurality of annular members, are formed in a tapered manner.

14. An injector for supplying fuel to an engine by injecting the fuel, the injector comprising:
a solenoid valve; and
a nozzle hole, wherein:
the nozzle hole is opened by the solenoid valve to inject the fuel; and
the solenoid valve includes:
a solenoid coil that is energized;
a stator that has the solenoid coil therein, and attracts an armature to one side in an axial direction of the armature upon the energization of the solenoid coil, wherein the stator is disposed on the one side of the armature in the axial direction;
a stopper that is arranged on an inner circumferential side of the stator, and restricts an amount of displacement of the armature toward the stator;
a housing that is arranged on the one side of the stator in the axial direction;
a terminal that is inserted in the housing, and electrically connected to the solenoid coil; and
a plurality of bushes that are received by the housing, and insulate the terminal from the housing, wherein:
the terminal is forcibly inserted into at least one of the plurality of bushes, and penetrates in the axial direction between one end face and an opposite end face of the one of the plurality of bushes, wherein the opposite end face is opposite from the one end face; and
an outer circumferential portion of a contact end face, which is one of the one end face and the opposite end face, with the contact end face being in contact with any one bush of the plurality of bushes other than the at least one of the plurality of bushes, is surrounded by a dielectric member.

15. The injector according to claim 14, wherein the dielectric member is the any one bush of the plurality of bushes other than the at least one of the plurality of bushes.
